(19) United States
(12) Patent Application Publication
(10) Pub. No.: US 2024/0309613 A1
(43) Pub. Date: Sep. 19, 2024

(54) OBJECT IDENTIFICATION METHOD, OBJECT IDENTIFICATION SYSTEM, AND OBJECT IDENTIFICATION DEVICE

(71) Applicant: NEC CORPORATION, Minato-ku,Tokyo (JP)

(72) Inventors: Tatsuya YOSHIMOTO, Tokyo (JP); Hiroshi YOSHIDA, Tokyo (JP)

(73) Assignee: NEC CORPORATION, Tokyo (JP)

(21) Appl. No.: 18/277,906

(22) PCT Filed: Feb. 26, 2021
(86) PCT No.: PCT/JP2021/007556

§ 371 Date: Aug. 18, 2023

(51) Int. Cl. E02F 9/26; E02F 3/43; G06T 7/11; G06T 7/50

(52) U.S. Cl. CPC E02F 9/261; E02F 3/439; G06T 7/11; G06T 7/50; G06T 2207/30252

(57) ABSTRACT

In order to move an object to a region to which the object can be moved, an object identification apparatus includes: an acquisition means for acquiring depth information indicating a depth of an area including the object; an extraction means for extracting, on the basis of the depth information of the object, a target region where a candidate of a movement target object to be moved is present; and an identification means for identifying, on the basis of the depth information regarding the vicinity of the target region, the movement target object to be moved by a work machine.

### TECHNICAL FIELD

The present invention relates to an object identification method, an object identification system, and an object identification apparatus, each of which is for identifying an object to be moved in a construction site.

### BACKGROUND ART

Conventionally, a technique for moving an object in a construction site has been known. As techniques related to this, there are inventions disclosed in Patent Literatures 1 and 2 below.

Patent Literature 1 relates to a control system of a work vehicle. The control system is a control system that is for a work vehicle and that is for carrying out dumping work in which an object is pushed out from an edge of a damping area. The control system includes a controller. The controller acquires damping area data that indicates a shape of then edge of the damping area and also acquires material data that indicates a shape of the object in the dumping area. The controller decides, on the basis of the material data, a plurality of segments into which the object is partitioned. The controller also decides dumping candidate positions along the edge of the dumping area. Furthermore, the controller decides a dumping position(s) in the dumping work according to combinations of the plurality of segments and the plurality of dumping candidate positions.

Patent Literature 2 relates to a control apparatus and a control method for a work machine. A control apparatus for a work machine includes a travel body, a swing body supported by the travel body and being capable of swinging about a swing center, and work equipment provided to the swing body and having a bucket. The control apparatus includes: a three-dimensional map acquisition unit that acquires a three-dimensional map indicating a shape around the work machine; a boundary identification unit that identifies a traveling road boundary line in terrain shown by the three-dimensional map, the traveling road boundary line that is a boundary line between a traveling road surface on which a transport vehicle is capable of traveling, and an excavation target for excavation by the work equipment; and an excavation start point determination unit that determines a point on the traveling road boundary line or a point above the traveling road boundary line as an excavation start point for excavation by the work equipment.

### CITATION LIST

### Patent Literature

### Patent Literature 1

International Publication No. WO 2019/008767

### Patent Literature 2

Japanese Patent Application Publication Tokukai No. 2020-033836

### SUMMARY OF INVENTION

### Technical Problem

In a construction site or the like, in order to keep work efficiency of a work machine as high as possible, it is preferable to appropriately identify, in accordance with conditions around a target region, a target object to be moved.

The invention disclosed in Patent Literature 1 carries out work in which the work vehicle is caused to run to an edge of a cliff and to push out a scraped object. This invention does not solve the above-described problem of appropriately identifying, in accordance with conditions around a target region, a target object to be moved.

Further, Patent Literature 2 is intended to plan excavation so that earth and sand will not be scattered on the running surface. The invention does not solve the above-described problem of appropriately identifying a target object to be moved in accordance with conditions around a target region.

An example aspect of the invention has been accomplished in view of the above problems, and its example object is to provide a technique capable of suppressing a decrease in work efficiency of a work machine by suitably identifying an object to be moved.

### Solution to Problem

A method according to an example aspect of the invention for identifying an object, includes: acquiring depth information indicating a depth of an area including the object; extracting, on the basis of the depth information of the object, a target region where a candidate of a movement target object to be moved is present; and identifying, on the basis of the depth information regarding the vicinity of the target region, the movement target object to be moved by a work machine.

An object identification system according to an example aspect of the invention includes: a detection means for detecting depth information indicating a depth of an area including the object; an extraction means for extracting, on the basis of the depth information of the object, a target region where a candidate of a movement target object to be moved is present; and an identification means for identifying, on the basis of the depth information regarding the vicinity of the target region, the movement target object to be moved by a work machine.

An object identification apparatus according to an example aspect of the invention includes: an acquisition means for acquiring depth information indicating a depth of an area including the object; an extraction means for extracting, on the basis of the depth information of the object, a target region where a candidate of a movement target object to be moved is present; and an identification means for identifying, on the basis of the depth information regarding the vicinity of the target region, the movement target object to be moved by a work machine.

### Advantageous Effects of Invention

According to an example aspect of the invention, since a movement target object to be moved can be suitably identified in accordance with conditions around a target region, a decrease in work efficiency of a work machine can be suppressed.

### BRIEF DESCRIPTION OF DRAWINGS

FIG. 1 is a block diagram illustrating a functional configuration of an object identification apparatus according to a first example embodiment of the invention.

FIG. 2 is a flowchart illustrating a flow of the object identification method according to the first example embodiment of the invention.

FIG. 3 is a block diagram illustrating a functional configuration of an object movement apparatus according to a second example embodiment of the invention.

FIG. 4 is a block diagram illustrating a functional configuration of an object movement apparatus according to a third example embodiment of the invention.

FIG. 5 is a diagram showing an example of a push target region.

FIG. 6 is a diagram showing a turning range of an arm of an excavation apparatus.

FIG. 7 is a diagram for illustrating division of an island that is to be a candidate of a push target.

FIG. 8 is a diagram for illustrating a turning angle θ; corresponding to each of divisional sub-islands.

FIG. 9 is a diagram for illustrating back regions of an island and sub-islands.

FIG. 10 is a diagram for illustrating a start point and an end point in a case where the island and sub-islands are pushed.

FIG. 11 is a diagram for illustrating the push order of the island and sub-islands.

FIG. 12 is a flowchart illustrating a processing procedure of an extraction unit, an identification unit, and a movement unit of the object movement apparatus.

FIG. 13 is a block diagram illustrating a functional configuration of an object identification system according to a fourth example embodiment of the invention.

FIG. 14 is a diagram illustrating an example of a hardware configuration of a computer.

### DESCRIPTION OF EMBODIMENTS

### First Example Embodiment

The following description will discuss a first example embodiment of the invention in detail with reference to the drawings. The present example embodiment is a basic form of example embodiments described later.

### (Configuration of Object Identification Apparatus)

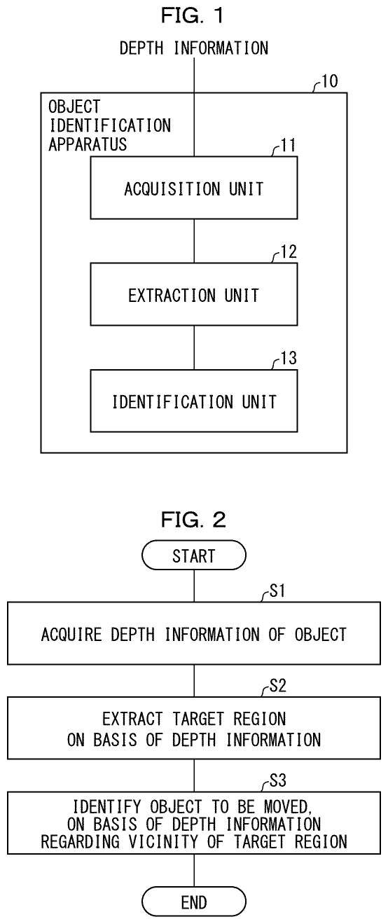

The following will discuss a configuration of an object identification apparatus 10 according to the present example embodiment, with reference to FIG. 1. FIG. 1 is a block diagram illustrating a functional configuration of the object identification apparatus 10 according to the first example embodiment of the invention. The object identification apparatus 10 includes an acquisition unit 11, an extraction unit 12, and an identification unit 13.

The acquisition unit 11 acquires depth information that indicates a depth of an area including an object. For example, a measurement apparatus such as a 3D sensor disposed at an upper portion of a work machine measures the depth information at a plurality of points in an area including an object to be moved. The acquisition unit 11 then acquires the depth information which have been measured by the measurement apparatus. Note that examples of the 3D sensor include cameras such as a depth camera, a stereo camera, and a time-of-flight (ToF) camera, laser sensors such as a 2D light detection and ranging (LiDAR) and a 3D LiDAR, radar sensors, and the like.

The measurement apparatus can be installed at an upper portion of the work machine, and can measure an object to be moved. In an environment in which objects (earth and sand) are sequentially added by a truck or the like, the measurement apparatus can be fixed.

Further, the measurement apparatus can be configured to be attached to a crane or the like and to move in accordance with movement of the work machine. Alternatively, the measurement apparatus can be attached to an upper portion of the work machine and move together with the work machine. The measurement apparatus can be installed on, for example, a ceiling or a beam or a column at which an area can be viewed from above, a high-place work vehicle, or an air vehicle such as a drone.

Note that in the present example embodiment, examples of the work machine may include excavation apparatuses (hydraulic excavators) such as a backhoe, Yumbo, and a power shovel, cranes such as a crawler crane, a truck crane, and a wheel crane, and bulldozers. These work machines are, for example, construction machines each capable of moving an object.

The extraction unit 12 extracts, on the basis of the depth information of the object, a region where a candidate of a movement target object to be moved is present (hereinafter, also referred to as a target region). In one example, the extraction unit 12 divides, into a plurality of divisional meshes, an image including the depth information of an area where the object is present. The extraction unit 12 extracts the target region by carrying out, on the basis of the depth information of the divisional meshes, a binarization process, an expansion/contraction process, and a labeling process.

Note that the depth information is information on a height which is measured by the measurement apparatus and up to which an object (earth and sand) that is to be a movement target is deposited. The height of deposition, for example, is the height from a lowest part of the deposition (e.g., the ground, if deposited on the ground) to a point where a surface of the object is present. Hereinafter, the height of the object deposited (height on the premise that an upward direction in the vertical direction is positive) is simply referred to as “height”. However, the expression “height” may not necessarily refer to the height from a specific place but may also be used to refer to a relative height of the surface of the object. Further, in the present specification, the expression “depth of an object” may be used. In other words, an object having a large height may be expressed as having a large depth, and an object having a small height may be expressed as having a small depth.

The identification unit 13 identifies the movement target object to be moved by the work machine, on the basis of the depth information regarding the vicinity of the target region. In one example, when one or more target regions are present, the identification unit 13 divides each of the target regions into divisional target regions. Then, the identification unit 13 identifies the depth information regarding the vicinity of the target regions from the depth information on an area where the object is present. Furthermore, the identification unit 13 identifies an object to be moved by the work machine by determining, for each of the divisional target regions, whether or not it is possible to move the object.

The identification unit 13 may identify the movement target object to be moved by the work machine, on the basis of the depth information regarding the vicinity of the target region and a distance from the work machine to the target region. For example, the identification unit 13 determines, on the basis of the depth information regarding the vicinity of the target region, whether or not there is an empty region to which the target object in the target region can be moved. The identification unit 13 identifies the object to be moved by work machine, on the basis of the following: whether or not the maximum distance from the work machine to the target region is within a distance that a work tool of the work machine can reach; and whether or not the minimum distance from the work machine to the target region is within a distance that the work tool of the work machine can reach. The work tool is, for example, a bucket of an excavation apparatus.

As described above, in the object identification apparatus 10 according to the present example embodiment, the identification unit 13 identifies, on the basis of the depth information regarding the vicinity of the target region, the movement target object to be moved by the work machine. Therefore, the identification unit 13 can suitably identify the movement target object to be moved.

### (Flow of Target Object Identification Method)

FIG. 2 is a flowchart illustrating a flow of the object identification method of the object identification apparatus 10 according to the first example embodiment of the invention. First, the acquisition unit 11 acquires the depth information that indicates a depth of an area where an object is present (S1). The extraction unit 12 then extracts, on the basis of the depth information of the object, a target region where a candidate of the movement target object to be moved is present (S2).

The identification unit 13 then identifies the movement target object to be moved by the work machine, on the basis of the depth information regarding the vicinity of the target region (S3).

The identification unit 13 may identify the movement target object to be moved by the work machine, on the basis of the depth information regarding the vicinity of the target region and the distance from the work machine to the target region.

As described above, in the object identification method according to the present example embodiment, the movement target object to be moved by the work machine is identified on the basis of the depth information regarding the vicinity of the target region. Therefore, the method makes it possible to move the object to a region to which the object can be moved.

Further, the movement target object to be moved by the work machine is identified on the basis of the depth information regarding the vicinity of the target region and the distance from the work machine to the target region. Therefore, the above-described method makes it possible to more accurately identify the target object to be moved.

### Second Example Embodiment

The following description will discuss a second example embodiment of the invention in detail with reference to the drawings. The same reference numerals are given to constituent elements which have functions identical with those described in the first example embodiment, and descriptions as to such constituent elements are not repeated.

### (Configuration of Object Movement System 1)

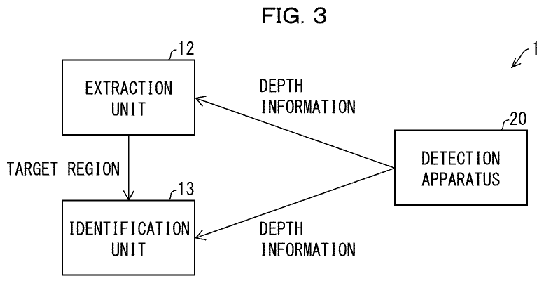

A configuration of the object movement system 1 according to the present example embodiment will be described with reference to FIG. 3. FIG. 3 is a block diagram showing a functional configuration of the object movement system 1 according to the second example embodiment of the invention. The object identification system 1 includes an extraction unit 12, an identification unit 13, and a detection apparatus 20.

The detection apparatus 20 detects depth information that indicates a depth of an area where the object is present. In one example, the detection apparatus 20 is constituted by a measurement apparatus such as a 3D sensor disposed at an upper portion of a work machine, and measures depths at a plurality of points in an area including earth and sand that is an excavation target. The detection apparatus 20 is connected to a communication network such as a LAN by a wire or in a wireless manner, and can communicate with the extraction unit 12 and the identification unit 13.

The extraction unit 12 extracts, on the basis of the depth information of the object, a target region where a candidate of a movement target object to be moved is present.

The identification unit 13 identifies the movement target object to be moved by the work machine, on the basis of the depth information regarding the vicinity of the target region.

Note that the extraction unit 12 and the identification unit 13 can be mounted on a single apparatus, or can be mounted on separate apparatuses. The extraction unit 12 and the identification unit 13 may be mounted on the work machine, or on another apparatus. Further, units may be each distributed on a cloud (i.e., on the communication network). For example, in a case where the units are mounted on a cloud or on separate apparatuses, information on each of the units is transmitted and received via the communication network, so that a process proceeds.

As described above, in the object identification system 1 according to present the example embodiment, the identification unit 13 identifies, on the basis of the depth information regarding the vicinity of the target region, the movement target object to be moved by the work machine. Therefore, the method makes it possible to move the object to a region to which the object can be moved.

### Third Example Embodiment

### (Configuration of Object Movement Apparatus 10b)

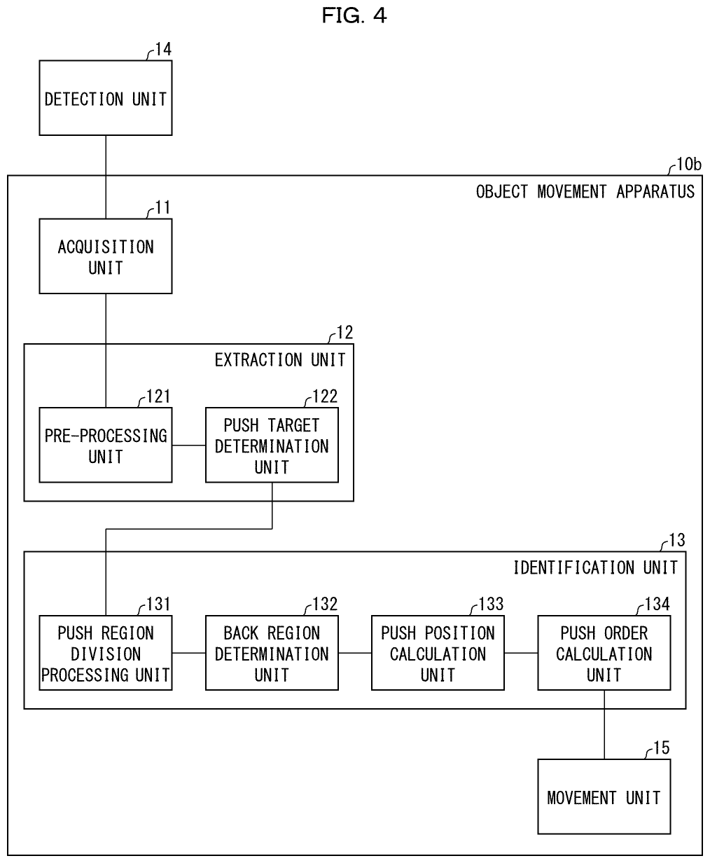

The following will discuss a configuration of an object movement apparatus 10b according to the present example embodiment, with reference to FIG. 4. FIG. 4 is a block diagram illustrating a functional configuration of the object movement apparatus 10b according to a third example embodiment of the invention. The object movement apparatus 10b includes an acquisition unit 11, an extraction unit 12, an identification unit 13, and a movement unit 15. Here, the acquisition unit 11, the extraction unit 12, and the identification unit 13 constitute the object identification apparatus according to the third example embodiment.

Hereinafter, in the present example embodiment, the following will describe a case where an excavation apparatus such as a backhoe is used as one example of a work machine.

The detection unit 14 is constituted by, for example, a measurement apparatus such as a 3D sensor disposed at an upper portion of the excavation apparatus. In this case, the detection unit 14 measures depth information at a plurality of points in an area including a target object to be moved, and outputs the depth information to the acquisition unit 11. The acquisition unit 11 acquires the depth information of the object that has been outputted from the detection unit 14.

The detection unit 14 has, for example, a conical field of view defined by a viewing angle θ from a central axis, and is capable of measuring two-dimensional coordinate information and the depth information of an excavation target object included in that range. For the detection unit 14, the number of specific points K (unit: number of points×meter) per unit area (1 m²) with respect to a measurement distance is determined and, as a height H (unit: meter) from the ground to the detection unit 14 decreases, the measurement range becomes narrower. Therefore, it is possible to carry out more detailed measurement. In the present example embodiment, an installation height H of the detection unit 14 is determined such that the number of measurement points in an area of 1 m² is not less than a predetermined number N1. Here, the predetermined number N1 can be set as appropriate while taking into consideration accuracy and the like demanded at a work site. For example, N1 can be 200, but this does not limit the present example embodiment.

The extraction unit 12 includes a pre-processing unit 121 and a push target determination unit 122. The pre-processing unit 121 mainly carries out a binarization process, an expansion/contraction process, and a labeling process and carries out classification into connected region groups (islands). The target determination unit 122 determines, from among the connected region groups (islands) as a result of classification by the pre-processing unit 121, an island that is to be a candidate of a push target.

The pre-processing unit 121 divides, into a plurality of meshes, an image including the depth information acquired by the acquisition unit 11. The meshes each correspond to, for example, a square of approximately 20 cm×20 cm, but the shape of the mesh may be rectangular or any other shape.

Next, the pre-processing unit 121 refers to the depth information in the meshes, calculates an average value of the depth information in each of the meshes, and binarizes each of the meshes. For example, the pre-processing unit 121 carries out binarization according to whether or not the average value of the depth information in each of the meshes is higher than a reference height Dₜₕ. The reference height Dₜₕ is, for example, a height of approximately 1.0 m to 1.5 m, and is approximately the height of an enclosure of a region (push target region) where an object such as earth and sand is present.

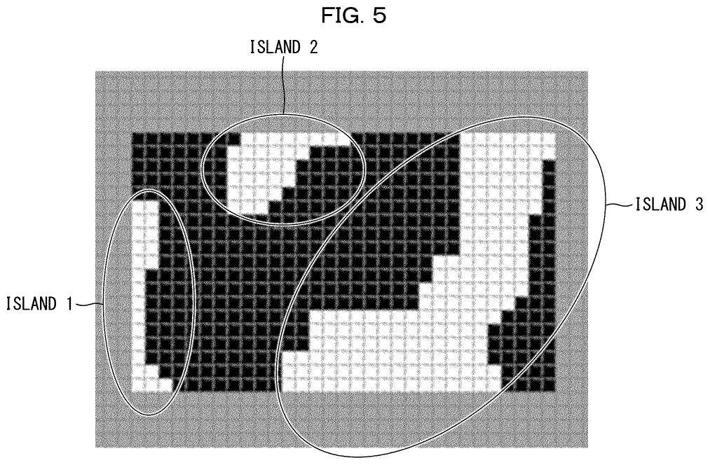

FIG. 5 is a diagram showing an example of a push target region. As illustrated in FIG. 5, the push target region measured by the detection unit 14 is divided into meshes and binarized. In FIG. 5, meshes represented in white refer to a region at a height of not less than the reference height Dₜₕ, and meshes represented in black refer to a region at a height of less than the reference height Dₜₕ. Note that push(ing) is work in which the excavation apparatus moves earth and sand to a back side and gathers the earth and sand. The “pushing earth and sand (object)” in the present example embodiment can also be regarded as, for example, “moving the object” in the first example embodiment and the present example embodiment. However, such an inclusion relationship is not intended to limit the present example embodiment.

Further, the push target region is an entire region which has been measured by the detection unit 14, and is mainly a region where the excavation apparatus can carry out excavation and pushing.

Next, the pre-processing unit 121 carries out the expansion/contraction process on the meshes which have been subjected to the binarization process. The expansion/contraction process is for removing minute regions (noise) by carrying out an expansion process and a contraction process on the image.

Next, the pre-processing unit 121 classifies the meshes into the connected region groups (islands) by carrying out the labeling process on each of the meshes. In FIG. 5, the push target region is classified into three islands (islands 1 to 3) by the labeling process.

Each of the connected region groups is a collection of meshes among the meshes that have been binarized. The meshes in the collection include meshes each of which has a height not less than a reference height Dₜₕ and to each of which at least another mesh having a height not less than the reference height Dₜₕ is adjacent in at least one selected from the group consisting of four directions of up, down, left, and right, and eight oblique directions. In the example embodiment, such a collection of meshes may also be referred to as an island.

The push target determination unit 122 determines, for each of islands which are labeled, an island that is to be a candidate of the push target, on the basis of the following: a total volume of earth and sand; a maximum distance and a minimum distance from a boom shaft of the excavation apparatus to a mesh included in the island; a maximum turning angle, a minimum turning angle, and a relative angle of each of the meshes included in the island.

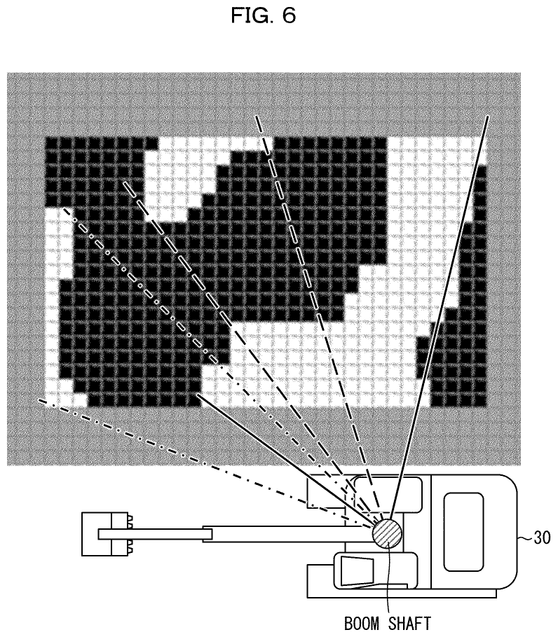

FIG. 6 is a diagram showing a turning range of an arm of an excavation apparatus 30. Dashed lines indicate the maximum and minimum turning angles relative to the meshes included in an island 1. Dotted lines indicate the maximum and minimum turning angles relative to the meshes included in an island 2. Solid lines indicate the maximum and minimum turning angles relative to the meshes included in an island 3.

The push target determination unit 122 determines, as an island that is to be a candidate of the push target, an island(s) that satisfies all of the following conditions.

(1) The total volume of the island is not less than a threshold Vₜₕ.

(2) The maximum distance from the boom shaft of the excavation apparatus 30 to a mesh included in the island is not more than the maximum distance that the arm can reach from the boom shaft.

(3) The minimum distance from the boom shaft of excavation apparatus 30 to a mesh included in the island is not less than the minimum distance that the arm can reach from the boom shaft.

In a case where the push target determination unit 122 determines that one or more islands that are to be candidates of the push target exist, the identification unit 13 carries out a division process on the islands and determines whether or not it is possible to carry out pushing. The identification unit 13 includes a push region division processing unit 131, a back region determination unit 132, a push position calculation unit 133, and a push order calculation unit 134.

The identification unit 13 identifies an object in the target region as the target object to be moved by the work machine, in a case where (i)) as described above, the identification unit 13 determines, on the basis of the depth information, that the depth of a region on the back of the target region relative to the work machine is not more than the first predetermined value and (ii) the target region is included in a movable range of the work machine.

The identification unit 13 divides the target region in accordance with the width of the bucket of the excavation apparatus and identifies, among divisional target regions, the object to be moved by the excavation apparatus.

In a case where the width of the island that is to be a candidate of the push target is greater than the lateral width of the bucket, the push region dividing unit 131 divides the island in accordance with the lateral width of the bucket in order to push the object by several pushes.

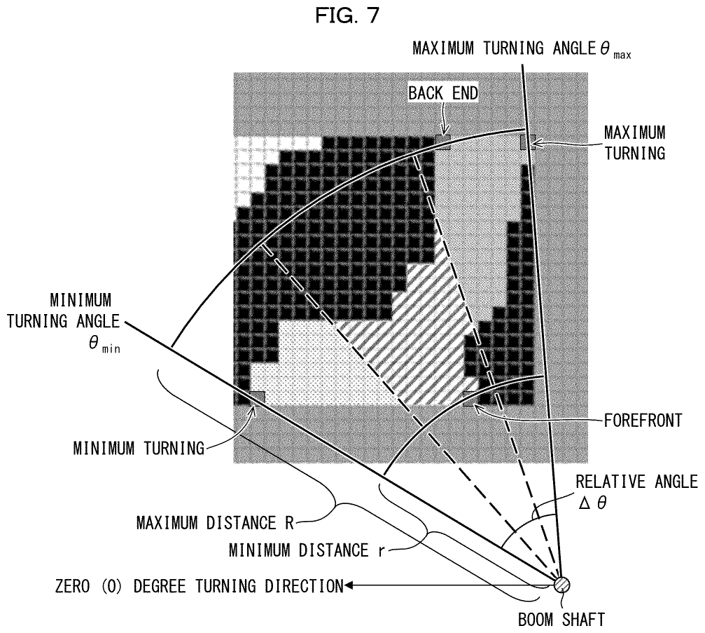

FIG. 7 is a diagram for illustrating division of the island as a candidate that is to be a candidate of the push target. In FIG. 7, only the island 3 in FIG. 5 is shown. Assuming that the maximum turning angle of the island is θₘₐₓ and the minimum turning angle of the island is θₘᵢₙ, the relative angle Δθ (rad) that covers the entire island is expressed by the following expression (Expression 1).

$$Δθ = {θ}_{max} - {θ}_{min} \qquad ( Expression 1 )$$

Further, on the assumption that the maximum distance from the boom shaft in the meshes included in the island is defined as R and the lateral width of the bucket is defined as W, the minimum number n of pushes necessary to push the entire island (number of divisions of the turning angle) is a minimum natural number which satisfies the following expression (Expression 2). In FIG. 6, the minimum number n of pushes is “3”.

$$n > Δθ / 2 \times {( arcsin ( W / 2 R ) )}^{- 1} \qquad ( Expression 2 )$$

Next, the push region division processing unit 131 calculates the turning angle for each of divisional islands. The turning angle θᵢ to the turning position of the arm of the excavation apparatus 30 for pushing the divisional island (turning line in the divisional island) is calculated by the following Expression (Expression 3).

$${θ}_{i} = {θ}_{min} + ( 2 ( i - 1 ) + 1 ) \times Δ θ / 2 n \qquad ( Expression 3 )$$

For an island (n=1) that does not need to be divided, the turning angle θ can be obtained by the following expression (Expression 4).

$$θ = {θ}_{min} + Δ θ / 2 \qquad ( Expression 4 )$$

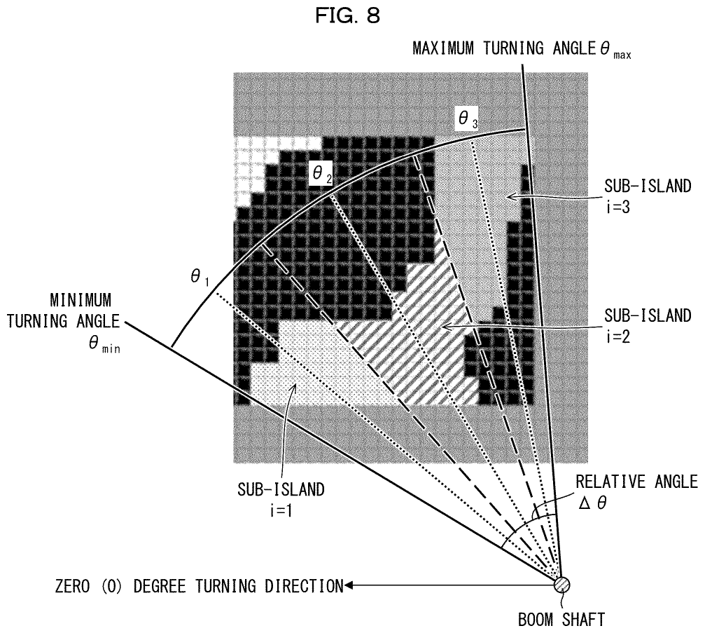

FIG. 8 is a diagram for illustrating the turning angle θᵢ corresponding to each of sub-islands obtained as a result of the division. As illustrated in FIG. 8, three divisional islands are defined as a sub-island 1 to a sub-island 3 (i=1 to 3), respectively. Then, the turning angles of the arms of the excavation apparatus 30 relative to the sub-islands 1 to 3 become θ₁ to θ₃, respectively.

Next, the back region determination unit 132 determines, for each of the sub-islands that are to be candidates of the push target, whether there is a region into which the object can be pushed on the back of the sub-island. Here, a back region of each of the sub-islands is defined as a circular region having a center point on the turning line in each of the islands. The distance Lᵢ to the center point of the back region is calculated by the following expression (Expression 5) with reference to the boom shaft. Note that Rᵢ is the maximum distance from the boom shaft to the sub-island i on the turning line. Further, in the present example embodiment, the back region of each of the sub-islands will be described as a circular region, but the shape of the back region is not limited to a circle but may be a shape other than a circle.

$${L}_{i} = {R}_{i} + Δ R \qquad ( Expression 5 )$$

Here, ΔR represents the radius of the back region, and should be defined to be proportional to the bucket size or the total volume of each of the sub-islands.

Further, the back region determination unit 132 calculates the average depth D_{avg} from the depth information in the back region, and determines whether or not the pushing is possible by the following expression (Expression 6). In a case where the following expression (Expression 6) is satisfied, the back region determination unit 132 determines that there is an empty space in the back region of the sub-island and that the sub-island is an island for which it is possible to carry out the pushing.

$${D}_{avg} < {D}_{th} - Δ D \qquad ( Expression 6 )$$

Note that Dₜₕ is the reference height described above. Further, ΔD should be defined to be proportional to the bucket size or the total volume of the sub-island.

In a case where the above condition is not satisfied, it is determined that pushing cannot be carried out for the sub-island. In this way, in a case where an average depth of a region on the back of a divisional target region relative to the excavation apparatus is not less than a second predetermined value, the identification unit 13 excludes the divisional target region from the candidate to be moved.

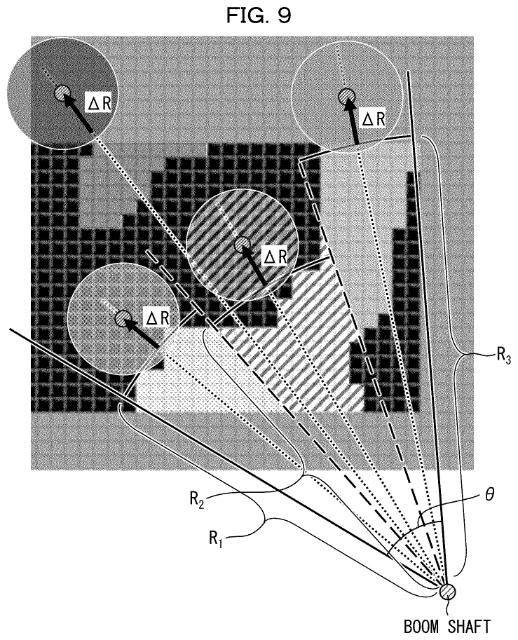

FIG. 9 is a diagram for illustrating a back region of each of the sub-islands. As illustrated in FIG. 9, the maximum distance from the boom shaft to the sub-island 1 on the turning line is R₁, and a circular region with a radius ΔR on the same turning line is set as the back region. Similarly, the maximum distance from the boom shaft to the sub-island 2 on the turning line is R₂, and a circular region with a radius ΔR on the same turning line is set as the back region. Similarly, the maximum distance from the boom shaft to the sub-island 3 on the turning line is R₃, and a circular region with a radius ΔR on the same turning line is set as the back region. Note that in FIG. 9, the back region of the island 2 shown in FIG. 5 is also illustrated.

The push position calculation unit 133 calculates, for the sub-islands which are determined such that pushing can be carried out by the back region determination unit 132, a start point and an end point for pushing each of the sub-islands by the bucket. The boom shaft push position calculation unit 133 performs calculation for each of the sub-islands, assuming that the position of the mesh which is on the turning line and which is at the minimum distance from the boom shaft is the start point. Further, the push position calculation unit 133 performs calculation, assuming that the position of the mesh which includes the center of the back region of each of the sub-islands is the end point.

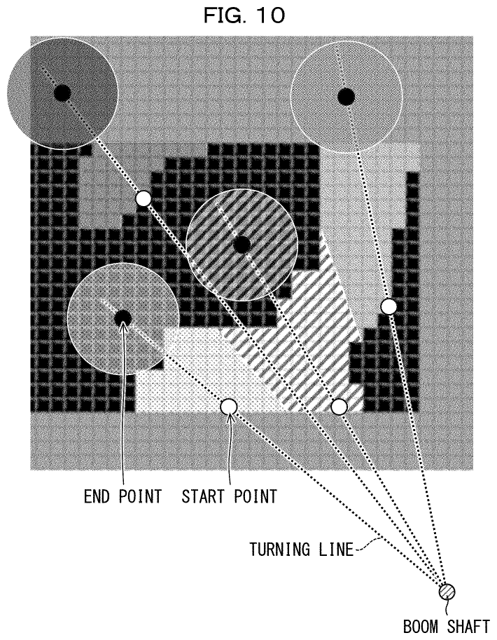

FIG. 10 is a diagram for illustrating the start point and the end point in pushing the island and sub-islands. As illustrated in FIG. 10, for example, the start point in pushing the sub-island 1 is set to a position of the mesh which is on the turning line and which is at the minimum distance from the boom shaft. Further, the end point in pushing the sub-island 1 is set to a position of the mesh which includes the center point of the back region of the sub-island and which is on the same turning line. Note that the same applies to the start and end points of each of the sub-islands 2 and 3 and the island 2.

When there are a plurality of islands and sub-islands for which pushing can be carried out, the push order calculation unit 134 determines the push order in the order from the longest distance to the shortest distance of distances from the boom shaft to the start points of the islands and sub-islands.

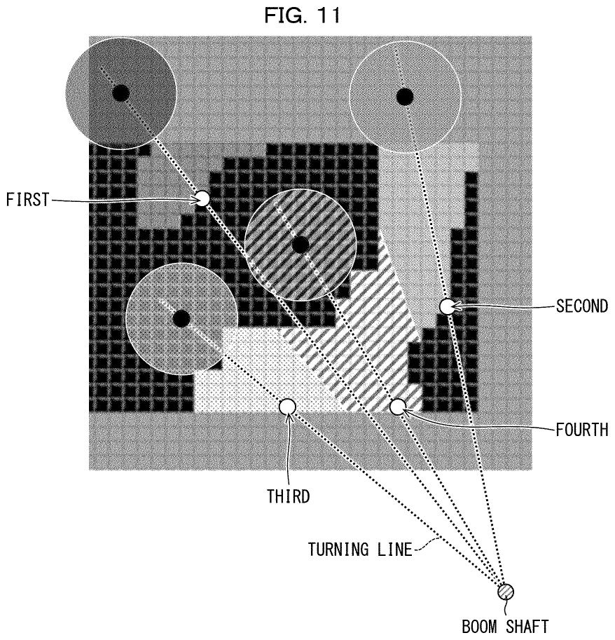

FIG. 11 is a diagram for illustrating the push order of the islands and sub-islands. As shown in FIG. 11, the push order of the island 2 whose start point is the farthest is set to first. Next, the push order of the sub-island 3 whose start point is the second farthest is set to second. Next, the push order of the sub-island 1 whose start point is the third farthest is set to third. Then, the order of the sub-island 2 whose start point is the nearest is set to fourth. Thus, by carrying out pushes in the order from the farther-side island or sub-island, it is possible to avoid interference in the pushing operation.

The movement unit 15 moves, by the excavation apparatus 30, the object (earth and sand) identified. For example, for a divisional target region (island), the movement unit 15 defines, as the start point, a point which is on the turning line of the arm and which is at the shortest distance from the boom shaft. Moreover, for the divisional target region (island), the movement unit 15 defines, as the end point, a point to which the target object (earth and sand) is moved. Then, the movement unit 15 causes the excavation apparatus 30 to move the object in the divisional target region (island) by moving the bucket from the start point to the end point.

In the present example embodiment, it is assumed that the object movement apparatus 10b is provided in the excavation apparatus 30 and the movement unit 15 outputs an instruction to a control apparatus (not shown) that controls, for example, travel of the excavation apparatus 30 and movement of the bucket. For example, the movement unit 15 outputs, as an instruction for causing the excavation apparatus 30 to move the target object, a control signal that indicates, for example, coordinate information indicating the start point and the end point, information on a trajectory (or a point where the trajectory passes) on which the bucket is moved in order to excavate, and/or a speed at which the bucket is to be moved.

The object movement apparatus 10b may be configured separately from the excavation apparatus. In such a configuration, the movement unit 15 may be configured to instruct the excavation apparatus to move the target object.

### Effects of Third Example Embodiment

In general, when work related to an object such as earth and sand is carried out using a work machine, the following situation may often occur: a situation in which the object comes close to the work machine due to collapse or the like of the object; or a situation in which the work machine goes close to the object. Alternatively, a situation in which the operation of the work machine moves the object into an undesirable region may occur. The occurrence of such a situation may lead to a decrease in work efficiency of work using the work machine.

According to the object movement apparatus 10b according to the present example embodiment, as described above, it is possible to suitably identify an object and to suitably move the object thus identified. Therefore, it is possible to suitably suppress the decrease in work efficiency.

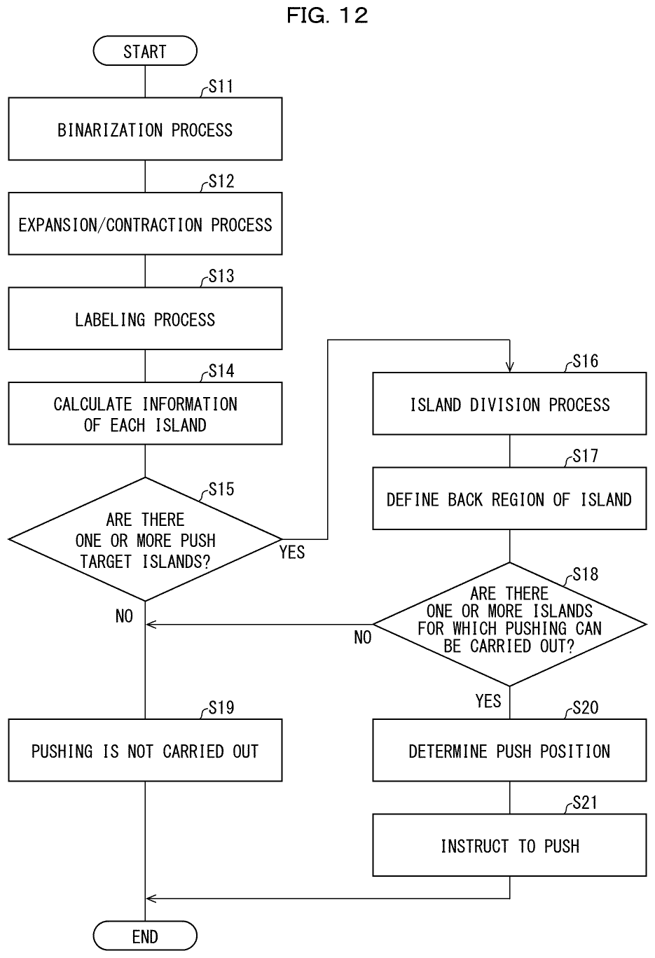

FIG. 12 is a flowchart illustrating a processing procedure of the extraction unit 12, the identification unit 13, and the movement unit 15 of the object movement apparatus 10b. First, the pre-processing unit 121 carries out the binarization process on a push target region that has been divided into meshes (S11), and carries out the expansion/contraction process on the meshes that have been binarized (S12).

Next, the pre-processing unit 121 classifies the meshes into the connected region groups (islands) by carrying out the labeling process on each of the meshes. Then, the push target determination unit 122 calculates information such as the total volume of the earth and sand of each of islands that have been labeled (S14).

Next, whether or not one or more islands that are to be candidates of the push target are present is determined (S15). In a case where one or more islands that are to be candidates of the push target are not present (S15, No), the process proceeds to step S19.

In addition, in a case where one or more islands that are to be candidates of the push target are present (S15, Yes), the push region division processing unit 131 carries out the division process on the islands (S16). Then, the back region determination unit 132 defines the back region of each of the islands and sub-islands (S17), and determines whether or not one or more islands and sub-islands that can be pushed into the back region(s) are present (S18).

In the case where one or more islands and sub-islands that can be pushed into the back region(s) are not present (S18, No), the process proceeds to step S19. In addition, in a case where one or more islands and sub-islands that can be pushed into the back region(s) are present (S18, Yes), the push position calculation unit 133 determines the push position of each of the islands and sub-islands (S20). Then, the push order calculation unit 134 determines the push order of each of the islands and sub-islands. The movement unit 15 causes, on the basis of the push position thus determined and the push order thus determined, the excavation apparatus 30 to push the object (earth and sand), and ends the process.

In step 19, since there are no islands or sub-islands that can be pushed into the back region(s), the movement unit 15 ends the process without pushing the object (earth and sand). As described above, the back region determination unit 132 calculates the average depth D_{avg} from the depth information in the back region, and, when the average depth D_{avg} is not more than a first predetermined value, determines that pushing for such a sub-island can be carried out. Therefore, it is possible to easily determine whether pushing for the sub-island can be carried out or not.

Further, in a case where the width of the island that is to be a candidate of the push target is larger than the lateral width of the bucket, the push region division processing unit 131 divides the island in accordance with the width of the bucket. Therefore, even in a case where the width of the island is larger than the lateral width of the bucket, it is possible to push the object (earth and sand) by the bucket.

Further, when the average depth D_{avg} in the back region is not less than the first predetermined value, the back region determination unit 132 excludes such a sub-island from the candidates for the push target. Therefore, it is possible to reduce the number of times of pushing operations to be carried out by the excavation apparatus 30, by reducing the push target region.

Further, the movement unit 15 causes the excavation apparatus 30 to move the target object in the divisional target region (island) by moving the bucket from the start point to the end point. Therefore, the movement unit 15 can easily carry out the pushing process of the earth and sand by controlling the excavation apparatus 30.

### Fourth Example Embodiment

The following description will discuss a fourth example embodiment of the invention in detail with reference to the drawings. The same reference numerals are given to constituent elements which have functions identical with those described in the third example embodiment, and descriptions as to such constituent elements are not repeated.

### (Configuration Example of Object Identification System)

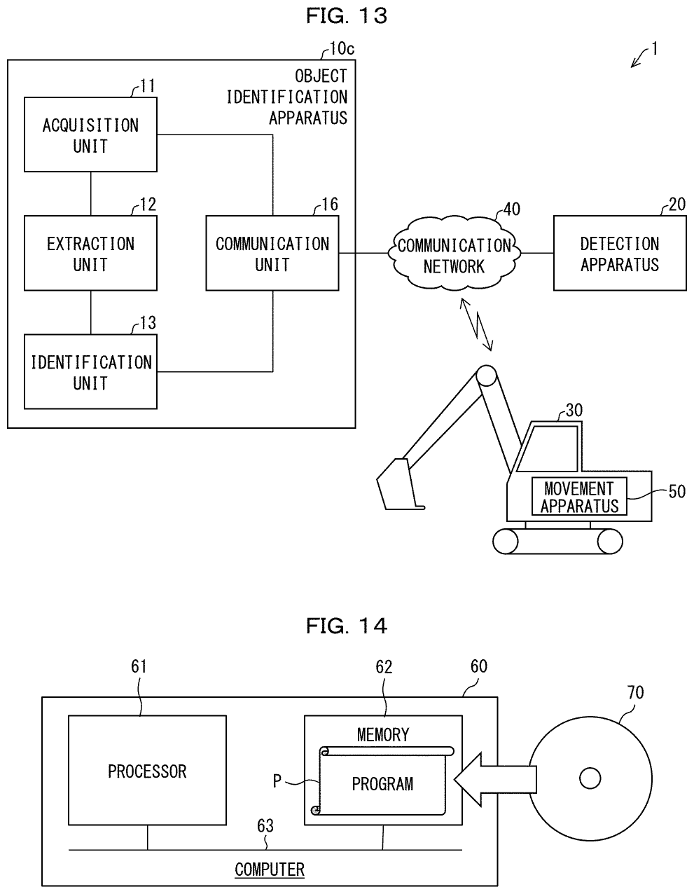

FIG. 13 is a block diagram illustrating a functional configuration of an object identification system 1 according to the fourth example embodiment of the invention. The object identification system 1 includes an object identification apparatus 10c, a detection apparatus 20, an excavation apparatus 30, a communication network 40, and a movement apparatus 50.

The detection apparatus 20 detects depth information of an object. In one example, the detection apparatus 20 is constituted by a measurement apparatus such as a 3D sensor or the like disposed at an upper portion of the excavation apparatus 30, and measures depths at a plurality of points in an area including earth and sand that is an excavation target. The detection apparatus 20 is connected to a communication network 40 such as a LAN by a wire or in a wireless manner, and can communicate with the object identification apparatus 10c.

The excavation apparatus 30 is wirelessly connected to the communication network 40 such as a LAN. The communication between the excavation apparatus 30 and the object identification apparatus 10c may be near field communication via a wireless LAN such as WiFi (registered trademark), beacons, Small Cell, local 5G, or local LTE.

The object identification apparatus 10c includes an acquisition unit 11, an extraction unit 12, an identification unit 13, and a communication unit 16. The communication unit 16 is connected to the communication network 40 such as a LAN and communicates with the detection apparatus 20 and the movement apparatus 50.

The acquisition unit 11 acquires an image including the depth information from the detection apparatus 20 through the communication unit 16 and outputs the image to the extraction unit 12.

The extraction unit 12 divides the image including the depth information into a plurality of divisional meshes. The extraction unit 12 extracts a target region by carrying out a binarization process, an expansion/contraction process, and a labeling process on the basis of the depth information of the divisional meshes.

The identification unit 13 determines, on the basis of the depth information regarding the vicinity of the target region, whether or not there is an empty region to which a target object (earth and sand) of an island that is to be a candidate of a push target can be moved. The identification unit 13 identifies the object to be moved by the excavation apparatus 30, on the basis of the following: whether or not the maximum distance from the excavation apparatus 30 to the island that is to be a candidate of the push target is a distance that the bucket can reach; and whether or not the minimum distance from the excavation apparatus 30 to the island that is a candidate of the push target is a distance that the bucket of the excavation apparatus 30 can reach.

The identification unit 13 determines the push positions and push order of each of islands and sub-islands, and transmits such information to the movement apparatus 50 via the communication unit 16.

The movement apparatus 50 is provided in the excavation apparatus 30, and is wirelessly connected to the communication network 40 such as a LAN. Accordingly, the movement apparatus 50 can communicate with the object identification apparatus 10c. Upon receipt of the push positions and push order of the islands and sub-islands from the object identification apparatus 10c, the movement apparatus 50 controls the excavation apparatus 30 and causes the excavation apparatus 30 to carry out pushing of the earth and sand.

Note that units of the object identification apparatus 10c may be in separate apparatuses. For example, the acquisition unit 11 and the extraction unit 12 may form one apparatus, and the identification unit 13 may form another apparatus. These units may be implemented in one apparatus or separate apparatuses. Further, the units may be each distributed on a cloud (i.e., on a communication network). For example, in a case where the units are mounted on a cloud or on separate apparatuses, respective pieces of information of the units are transmitted and received via the communication network 40, so that a process proceeds.

The excavation apparatus 30 may be operated by attaching, as an attachment, the movement apparatus 50 to a control lever or the like of the excavation apparatus 30.

As described above, in the object identification system 1 according to present the example embodiment, the identification unit 13 identifies the movement target object to be moved by a work machine on the basis of the depth information regarding the vicinity of the target region. Therefore, the method makes it possible to move the object to a region to which the object can be moved.

### [Software Implementation Example]

The functions of part of or all of the object identification apparatuses 10, 10a, 10b, and 10c can be realized by hardware such as an integrated circuit (IC chip) or can be alternatively realized by software.

In the latter case, each of the object identification apparatuses 10, 10a, 10b, and 10c is realized by, for example, a computer that executes instructions of a program that is software realizing the foregoing functions. FIG. 14 illustrates an example of such a computer (hereinafter, referred to as “computer 60”). The computer 60 includes at least one processor 61 and at least one memory 62 which are connected to each other via an internal bus 63. The memory 62 stores a program P for causing the computer 60 to function as each of the object identification apparatuses 10, 10a, 10b, and 10c. In the computer 60, the processor 61 reads the program P from the memory 62 and executes the program P, so that the functions of the object identification apparatuses 10, 10a, 10b, and 10c are realized.

As the processor 61, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, general-purpose computing on graphics processing units (GPGPU), or a combination of these. The memory 62 can be, for example, a flash memory, a hard disk drive (HDD), a solid state drive (SSD), or a combination of these.

Note that the computer 60 can further include a random access memory (RAM) in which the program P is loaded when the program P is executed and in which various kinds of data are temporarily stored. The computer 60 can further include a communication interface for carrying out transmission and reception of data with other apparatuses. The computer 60 can further include an input-output interface for connecting input-output apparatuses such as a keyboard, a mouse, a display and a printer.

The program P can be stored in a non-transitory tangible storage medium 70 which is readable by the computer 60. The storage medium 70 can be, for example, a compact disc-read only memory (CD-ROM), a digital versatile disc (DVD), a tape, a disk, a card, a semiconductor memory, a programmable logic circuit, or the like. The computer 60 can obtain the program P via the storage medium 70. The program P can be transmitted via a transmission medium. The transmission medium can be, for example, a communication network, a broadcast wave, or the like. The computer 60 can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### Supplementary Note 1

A method for identifying an object, comprising:
acquiring depth information indicating a depth of an area including the object;
extracting, on the basis of the depth information of the object, a target region where a candidate of a movement target object to be moved is present; and identifying, on the basis of the depth information regarding the vicinity of the target region, the movement target object to be moved by a work machine.

The above configuration makes it possible to suitably identify the movement target object to be moved.

### Supplementary Note 2

The method according to supplementary note 1, wherein in the identifying the movement target object,
the movement target object to be moved is identified on the basis of the depth information regarding the vicinity of the target region and a distance from the work machine to the target region.

The above configuration makes it possible to more accurately identify the movement target object to be moved.

### Supplementary Note 3

The method according to supplementary note 1 or 2, wherein the identifying the movement target object includes
identifying the target region, as the movement target object to be moved by the work machine, in a case where (i) it is determined, on the basis of the depth information of the object, that the depth of the region on the back of the target region relative to the work machine is not more than a first predetermined value and (ii) the target region is included in a movable range of the work machine.

The above configuration makes it possible to easily determine whether or not the movement target object can be moved.

### Supplementary Note 4

The method according to any one of supplementary notes 1 to 3, wherein the identifying the movement target object includes:
dividing the target region so as to make divisional target regions, in accordance with a width of equipment that the work machine is to use for moving the movement target object; and
identifying the movement target object to be moved, from among the divisional target regions obtained by dividing the target region.

The above configuration makes it possible to push the object by equipment to be used for movement, even in a case where the width of the target region is larger than the lateral width of the equipment to be used for movement.

### Supplementary Note 5

The method according to supplementary note 4, wherein the identifying the movement target object includes
in a case where an average depth of a region on the back of a divisional target region among the divisional target regions relative to the work machine is not less than a second predetermined value, excluding the divisional target region from the candidate to be moved.

The above configuration makes it possible to reduce the number of times of pushing operations by an excavation apparatus by reducing the push target region.

### Supplementary Note 6

The method according to supplementary note 4 or 5, wherein:
the work machine is an excavation apparatus; and
the method further includes moving the movement target object identified, with use of the excavation apparatus.

The above configuration makes it possible to easily carry out a movement process of the movement target object by controlling the excavation apparatus.

### Supplementary Note 7

The method according to supplementary note 6, wherein in the moving the movement target object with use of the excavation apparatus:
in each of the divisional target regions, a point which is on a turning line of an arm and which is at a shortest distance from a boom shaft is defined as a start point;
in each of the divisional target regions, a point to which the movement target object is moved is defined as an end point; and
the movement target object in each of the divisional target regions is moved by moving a bucket from the start point to the end point.

The above configuration makes it possible to easily carry out the movement process of the movement target object by controlling the excavation apparatus.

### Supplementary Note 8

An object identification system comprising:
a detection means for detecting depth information indicating a depth of an area including the object;
an extraction means for extracting, on the basis of the depth information of the object, a target region where a candidate of a movement target object to be moved is present; and
an identification means for identifying, on the basis of the depth information regarding the vicinity of the target region, the movement target object to be moved by a work machine.

The above configuration makes it possible to suitably identify the movement target object to be moved.

### Supplementary Note 9

The object identification system according to supplementary note 8, wherein the identification means identifies the movement target object to be moved, on the basis of the depth information regarding the vicinity of the target region and a distance from the work machine to the target region.

The above configuration makes it possible to more accurately identify the movement target object to be moved.

### Supplementary Note 10

The object identification system according to supplementary note 8 or 9, wherein
the identification means identifies the target region, as the movement target object to be moved by the work machine, in a case where (i) the identification means determines, on the basis of the depth information of the object, that the depth of the region on the back of the target region relative to the work machine is not more than a first predetermined value and (ii) the target region is included in a movable range of the work machine.

The above configuration makes it possible to easily determine whether or not the movement target object can be moved.

### Supplementary Note 11

The object identification system according to any one of supplementary notes 8 to 10, wherein:
the work machine is an excavation apparatus;
the identification means divides the target region so as to make divisional target regions, in accordance with a width of equipment that the work machine is to use for moving the movement target object; and
the identification means identifies the movement target object to be moved, from among the divisional target regions obtained by dividing the target region.

The above configuration makes it possible to push the object by equipment to be used for movement, even in a case where the width of the target region is larger than the lateral width of the equipment to be used for movement.

### Supplementary Note 12

The object identification system according to supplementary note 11, wherein
in a case where an average depth of a region on the back of a divisional target region among the divisional target regions relative to the work machine is not less than a second predetermined value, the identification means excludes the divisional target region from the candidate to be moved.

The above configuration makes it possible to reduce the number of times of pushing operations by an excavation apparatus by reducing the push target region.

### Supplementary Note 13

The object identification system according to supplementary note 11 or 12, wherein:
the work machine is an excavation apparatus; and
the object identification system further includes a movement means for moving the movement target object identified, with use of the excavation apparatus.

The above configuration makes it possible to easily carry out a movement process of the movement target object by controlling the excavation apparatus.

### Supplementary Note 14

The object identification system according to supplementary note 13, wherein:
in each of the divisional target regions, the movement means defines, as a start point, a point which is on a turning line of an arm and which is at a shortest distance from a boom shaft;
in each of the divisional target regions, the movement means defines, as an end point, a point to which the movement target object is moved; and
the movement means moves the movement target object in each of the divisional target regions by moving a bucket from the start point to the end point.

The above configuration makes it possible to easily carry out the movement process of the movement target object by controlling the excavation apparatus.

### Supplementary Note 15

An object identification apparatus comprising:
an acquisition means for acquiring depth information indicating a depth of an area including the object;
an extraction means for extracting, on the basis of the depth information of the object, a target region where a candidate of a movement target object to be moved is present; and
an identification means for identifying, on the basis of the depth information regarding the vicinity of the target region, the movement target object to be moved by a work machine.

The above configuration makes it possible to suitably identify the movement target object to be moved.

### Supplementary Note 16

The object identification apparatus according to supplementary note 15, wherein the identification means identifies the movement target object to be moved, on the basis of the depth information regarding the vicinity of the target region and a distance from the work machine to the target region.

The above configuration makes it possible to more accurately identify the movement target object to be moved.

### Supplementary Note 17

The object identification apparatus according to supplementary note 15 or 16, wherein
the identification means identifies the target region, as the movement target object to be moved by the work machine, in a case where (i) the identification means determines, on the basis of the depth information of the object, that the depth of the region on the back of the target region relative to the work machine is not more than a first predetermined value and (ii) the target region is included in a movable range of the work machine.

The above configuration makes it possible to easily determine whether or not the movement target object can be moved.

### Supplementary Note 18

The object identification apparatus according to any one of supplementary notes 15 to 17, wherein:
the work machine is an excavation apparatus;
the identification means divides the target region so as to make divisional target regions, in accordance with a width of equipment that the work machine is to use for moving the movement target object; and
the identification means identifies the movement target object to be moved, from among the divisional target regions obtained by dividing the target region.

The above configuration makes it possible to push the object by equipment to be used for movement, even in a case where the width of the target region is larger than the lateral width of the equipment to be used for movement.

### Supplementary Note 19

The object identification apparatus according to supplementary note 18, wherein
in a case where an average depth of a region on the back of a divisional target region among the divisional target regions relative to the work machine is not less than a second predetermined value, the identification means excludes the divisional target region from the candidate to be moved.

The above configuration makes it possible to reduce the number of times of pushing operations by an excavation apparatus by reducing the push target region.

### Supplementary Note 20

The object identification apparatus according supplementary note 18 or 19, wherein:
the work machine is an excavation apparatus; and
the object identification apparatus further includes a movement means for moving the movement target object identified, with use of the excavation apparatus.

The above configuration makes it possible to easily carry out a movement process of the movement target object by controlling the excavation apparatus.

### Supplementary Note 21

The object identification apparatus according to supplementary note 20, wherein:
in each of the divisional target regions, the movement means defines, as a start point, a point which is on a turning line of an arm and which is at a shortest distance from a boom shaft;
in each of the divisional target regions, the movement means defines, as an end point, a point to which the movement target object is moved; and the movement means moves the movement target object in each of the divisional target regions by moving a bucket from the start point to the end point.

The above configuration makes it possible to easily carry out the movement process of the movement target object by controlling the excavation apparatus.

### Supplementary Note 22

A computer program for causing a computer to function as an object identification apparatus, the program causing the computer to function as:
an acquisition means for acquiring depth information indicating a depth of an area including the object;
an extraction means for extracting, on the basis of the depth information of the object, a target region where a candidate of a movement target object to be moved is present; and
an identification means for identifying, on the basis of the depth information regarding the vicinity of the target region, the movement target object to be moved by a work machine.

### Supplementary Note 23

An object identification apparatus including at least one processor, the at least one processer carrying out:
a process of acquiring depth information indicating a depth of an area including the object;
a process of extracting, on the basis of the depth information of the object, a target region where a candidate of a movement target object to be moved is present; and
a process of identifying, on the basis of the depth information regarding the vicinity of the target region, the movement target object to be moved by a work machine.

Note that the object identification apparatus can further include a memory. In the memory, a program for causing the processor to carry out the acquisition process, the extraction process, and the identification process can be stored. The program can be stored in a computer-readable non-transitory tangible storage medium.

### REFERENCE SIGNS LIST

1 object identification system
10, 10a, 10b, 10c object identification apparatus
11 acquisition unit
12 extraction unit
13 identification unit
14 detection unit
15 movement unit
20 detection apparatus
30 excavation apparatus
40 communication network
50 movement apparatus
60 computer
61 processor
62 memory
63 internal bus
70 storage medium
121 pre-processing unit
122 push target determination unit
131 push region division processing unit
132 back region determination unit
133 push position calculation unit
134 push order calculation unit
P program

What is claimed is:

1. A method for identifying an object, comprising:
acquiring depth information indicating a depth of an area including the object;
extracting, on the basis of the depth information of the object, a target region where a candidate of a movement target object to be moved is present; and
identifying, on the basis of the depth information regarding the vicinity of the target region, the movement target object to be moved by a work machine.

2. The method according to claim 1, wherein in the identifying the movement target object,
the movement target object to be moved is identified on the basis of the depth information regarding the vicinity of the target region and a distance from the work machine to the target region.

3. The method according to claim 1, wherein the identifying the movement target object includes
identifying the target region, as the movement target object to be moved by the work machine, in a case where (i) it is determined, on the basis of the depth information of the object, that the depth of the region on the back of the target region relative to the work machine is not more than a first predetermined value and (ii) the target region is included in a movable range of the work machine.

4. The method according to claim 1, wherein the identifying the movement target object includes:
dividing the target region so as to make divisional target regions, in accordance with a width of equipment that the work machine is to use for moving the movement target object; and
identifying the movement target object to be moved, from among the divisional target regions obtained by dividing the target region.

5. The method according to claim 4, wherein the identifying the movement target object includes
in a case where an average depth of a region on the back of a divisional target region among the divisional target regions relative to the work machine is not less than a second predetermined value, excluding the divisional target region from the candidate to be moved.

6. The method according to claim 4, wherein:
the work machine is an excavation apparatus; and
the method further includes moving the movement target object identified, with use of the excavation apparatus.

7. The method according to claim 6, wherein in the moving the movement target object with use of the excavation apparatus:
in each of the divisional target regions, a point which is on a turning line of an arm and which is at a shortest distance from a boom shaft is defined as a start point;
in each of the divisional target regions, a point to which the movement target object is moved is defined as an end point; and
the movement target object in each of the divisional target regions is moved by moving a bucket from the start point to the end point.

8. An object identification system comprising at least one processor, the at least one processor carrying out:
a detection process of detecting depth information indicating a depth of an area including the object;
an extraction process of extracting, on the basis of the depth information of the object, a target region where a candidate of a movement target object to be moved is present; and
an identification process of identifying, on the basis of the depth information regarding the vicinity of the target region, the movement target object to be moved by a work machine.

9. The object identification system according to claim 8, wherein in the identification process, the at least one processor identifies the movement target object to be moved, on the basis of the depth information regarding the vicinity of the target region and a distance from the work machine to the target region.

10. The object identification system according to claim 8, wherein in the identification process,
the at least one processor identifies the target region, as the movement target object to be moved by the work machine, in a case where (i) the at least one processor determines, on the basis of the depth information of the object, that the depth of the region on the back of the target region relative to the work machine is not more than a first predetermined value and (ii) the target region is included in a movable range of the work machine.

11. The object identification system according to claim 8, wherein in the identification process:
the at least one processor divides the target region so as to make divisional target regions, in accordance with a width of equipment that the work machine is to use for moving the movement target object; and
the at least one processor identifies the movement target object to be moved, from among the divisional target regions obtained by dividing the target region.

12. The object identification system according to claim 11, wherein in the identification process,
in a case where an average depth of a region on the back of a divisional target region among the divisional target regions relative to the work machine is not less than a second predetermined value, the at least one processor excludes the divisional target region from the candidate to be moved.

13. The object identification system according to claim 11, wherein:
the work machine is an excavation apparatus; and
the at least one processor carries out a movement process for moving the movement target object identified, with use of the excavation apparatus.

14. The object identification system according to claim 13, wherein in the movement step:
in each of the divisional target regions, the at least one processor defines, as a start point, a point which is on a turning line of an arm and which is at a shortest distance from a boom shaft;
in each of the divisional target regions, the at least one processor defines, as an end point, a point to which the movement target object is moved; and
the at least one processor moves the movement target object in each of the divisional target regions by moving a bucket from the start point to the end point.

15. An object identification apparatus comprising at least one processor, the at least one processor carrying out:
an acquisition process of acquiring depth information indicating a depth of an area including the object;
an extraction process of extracting, on the basis of the depth information of the object, a target region where a candidate of a movement target object to be moved is present; and
an identification process of identifying, on the basis of the depth information regarding the vicinity of the target region, the movement target object to be moved by a work machine.

16. The object identification apparatus according to claim 15, wherein in the identification process, that at least one processor identifies the movement target object to be moved, on the basis of the depth information regarding the vicinity of the target region and a distance from the work machine to the target region.

17. The object identification apparatus according to claim 15, wherein in the identification process,
the at least one processor identifies the target region, as the movement target object to be moved by the work machine, in a case where (i) the at least one processor determines, on the basis of the depth information of the object, that the depth of the region on the back of the target region relative to the work machine is not more than a first predetermined value and (ii) the target region is included in a movable range of the work machine.

18. The object identification apparatus according to claim 15, wherein:
the work machine is an excavation apparatus;
in the identification process,
the at least one processor divides the target region so as to make divisional target regions, in accordance with a width of equipment that the work machine is to use for moving the movement target object; and
the at least one processor identifies the movement target object to be moved, from among the divisional target regions obtained by dividing the target region.

19. The object identification apparatus according to claim 18, wherein in the identification process,
in a case where an average depth of a region on the back of a divisional target region among the divisional target regions relative to the work machine is not less than a second predetermined value, the at least one processor excludes the divisional target region from the candidate to be moved.

20. The object identification apparatus according to claim 18, wherein:
the work machine is an excavation apparatus; and
the at least one processor carries out a movement process of moving the movement target object identified, with use of the excavation apparatus.

21. (canceled)
